(19) United States
(12) Patent Application Publication
(10) Pub. No.: US 2018/0124995 A1
(43) Pub. Date: May 10, 2018

(54) Superabsorbent Polymer Seed Coating Compositions

(71) Applicant: Seed Enhancements LLC, Caldwell, ID (US)

(72) Inventor: Steven M. Luttrell, Nampa, ID (US)

(21) Appl. No.: 15/862,304

(22) Filed: Jan. 4, 2018

Related U.S. Application Data
(63) Continuation-in-part of application No. 15/784,948, filed on Oct. 16, 2017.
(60) Provisional application No. 62/481,365, filed on Apr. 4, 2017.
(60) Provisional application No. 62/408,370, filed on Oct. 14, 2016.

(51) Int. Cl. A01C 1/06; B01J 20/26; B01J 20/32; B01J 20/12; B01J 20/04; B05D 7/00

(52) U.S. Cl. CPC A01C 1/06; B01J 20/26; B01J 20/3268; B05D 7/56; B01J 20/043; B01J 20/3236; B01J 20/12

(57) ABSTRACT

Disclosed herein are several exemplary seed coating compositions, and exemplary methods for creating and using the same. Also disclosed are several exemplary seed coating manufacturing processes, and the products created by such processes. The seed coating compositions are for decreasing dusting and increasing the quality of coated seeds, and comprise an effective amount of clay mineral.

### PRIORITY/CROSS-REFERENCE TO RELATED APPLICATIONS

This application is a continuation-in-part application of pending application Ser. No. 15/784,948, filed 2017 Oct. 16, which is a non-provisional application of provisional application Ser. Nos. 62/481,365 (filed 2017 Apr. 4) and 62/408,370 (filed 2016 Oct. 14), all the disclosures of which are incorporated herein by this reference.

### TECHNICAL FIELD

The disclosure generally relates to the field of agricultural seed coating.

### BACKGROUND

Seed coatings have been used as means for protecting and enhancing the environment next to the pericarp of a seed, to control seed germination, and/or improve seedling survival and growth rate. Toward these ends, various additives have been included in seed coatings, including agrochemicals, Rhizobium bacteria, nutrients, beneficial elements, and plant growth regulators. Such additives can be effective in improving seed germination and seedling survival and growth in the face of diseases, insects, low soil pH, and poor soil fertility. By including these additives in seed coatings, the additives are placed at the interface between seed and soil. This close proximity to the interface between seed and soil maximizes the effect of the additives and reduces waste and environmental impact compared to the method of broadcasting such additives over a field containing uncoated seeds.

A common type of agent included in seed coatings is what is referred to as a water-absorbing additive, such as superabsorbent polymer. Water-absorbing additives readily swell, absorbing and retaining moisture after the seed has been planted in the ground. By bringing such moisture closer to the seed and holding the moisture there, the seed will more rapidly germinate.

To apply agents (including water-absorbing additives) to a seed or to a coated seed to form a seed coating layer, a carrier must be utilized. Typically, the carrier is water or is water-based. After the seed coating layer is applied to the seed/coated seed, the seed/coated seed must then be dried to remove at least a portion of the carrier from the seed/coated seed. If such a portion of the carrier is not so removed, then the coated seeds may stick together, the coated seeds may mold while stored, and/or the coated seeds may germinate before planting.

When the carrier is of a type able to be absorbed by the water-absorbing additive (such as water), additional issues occur, namely, the water-absorbing additive absorbs a portion of the carrier (water). In absorbing the carrier, the water-absorbing additive swells. As the coated seed is then dried, and the water is removed from the coated seed, the water-absorbing additive shrinks. This swelling then shrinking process takes place during the drying process and damages the seed coating layer(s), causing damage to the seed coating layer, and resulting in portions of the seed coating layers flaking off (also known as “dusting”. It has been estimated that seventy five percent (75%) of the water-absorbing additive water-absorbing additive added to a traditional seed coating frequently dusts off during the drying process.

This problem can be further compounded when limestone is used as one of the main ingredients in the coating. When limestone is used, the limestone absorbs a portion of the carrier, resulting in increased dusting issues.

The end result of the current prior art process is frequently a dusty, undercoated, and less durable seed coating. Due to dusting off, the coated seeds have less water-absorbing additive attached to each seed and/or seeds will have differing amounts of water-absorbing additive attached thereto. Having less water-absorbing additive results in a decreasing the amount of water available for storing around each seed after planting. Having less water available decreases seedling survival rates, especially when there are times of little or no water available after planting. Finally, having differing amounts of water-absorbing additive means that different seedlings have differing chances of survival and abilities to flourish in the ground.

### SUMMARY OF THE DISCLOSURE

Disclosed herein are several exemplary seed coating compositions, coated seeds, methods of producing coated seeds, seed coating manufacturing processes, methods of creating seed coating compositions, processes of coating seeds, and methods of using coated seeds created utilizing one of the same.

An exemplary coated seed comprises a seed, and a seed coating on the seed. The seed coating comprises a plurality of seed coating layers, including an inner seed coating layer of a clay mineral, and an outer seed coating layer of a water-absorbing additive. Preferably, the clay mineral is bentonite, preferably powdered bentonite. Preferably, the water-absorbing additive is a superabsorbent polymer. Preferably, a binder is used for binding the agents comprising the seed coating layers into layers. Preferably, the seed coating includes a seed coating layer comprising at least one filler, preferably a mineral filler like limestone, applied as a first seed coating layer before the inner seed coating layer (the second seed coating layer) of clay mineral. In such a configuration, outer seed coating layer would be a third seed coating layer. Preferably, the seed coating includes at least one additive applied before the inner seed coating layer (second seed coating layer) of clay mineral. The additive can be applied as part of the first seed coating layer or as one or more seed coating layers between the first seed coating layer and the second seed coating layer. Likewise, additional seed coating layers comprising filler and/or additives could be present between the first and second seed coating layers.

An exemplary process of coating seeds comprises the steps of: providing a quantity of seeds; coating the seeds with a binder to create coated seeds; coating the seeds with a filler; coating the seeds with a filler and additional binder; coating the coated seeds with a clay mineral and additional binder; coating the seeds with a water-absorbing additive; compacting the coated seeds; and drying the coated seeds. Preferably, the clay mineral is bentonite clay, the water-absorbing additive is superabsorbent polymer, and the filler is limestone.

Additional understanding of the compositions, methods, processes and products contemplated and/or claimed by the inventor can be gained by reviewing the detailed description of exemplary devices and methods, presented below.

### Definitions

The use of “e.g.,” “etc,” “for instance,” “in example,” “for example,” and “or” and grammatically related terms indicates non-exclusive alternatives without limitation, unless otherwise noted. The use of “including” and grammatically related terms means “including, but not limited to,” unless otherwise noted. The use of the articles “a,” “an,” “the,” and “species” are meant to be interpreted as referring to the singular as well as the plural, unless the context clearly dictates otherwise. Thus, for example, reference to “clay mineral” includes two or more such clay minerals, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification, are intended to take on their ordinary and customary meanings which denote approximation, unless the context clearly dictates otherwise.

The use of “seed” means an embryonic plant enclosed in a protective outer covering, unless the context clearly dictates otherwise. The seeds with which the present invention is useful can be of any species. In some embodiments, the seed is grass seed (e.g., perennial ryegrass, fine fescue, Kentucky bluegrass, tall fescue, Bermuda grass, Zoysia grass, Bahiagrass, Centipede grass, or mixtures thereof). In some embodiments, the seeds are for plant species that are agronomically important. These plant species include, but are not limited to, corn, peanut, canola/rapeseed, soybean, curcubits, crucifers, cotton, rice, sorghum, sugar beet, wheat, barley, rye, sunflower, tomato, sugarcane, tobacco, oats, as well as other vegetable crops, leaf crops and flower crops.

The use of “pericarp” means the outer protective covering of a seed, also known as a “seed coat,” unless the context clearly dictates otherwise.

The use of “agent” means a component of a seed treatment with which seeds are treated prior to planting, unless the context clearly dictates otherwise. Examples of agents include, but are not limited to clay minerals, water-absorbing additives, fillers, binders, and additives.

The use of “dusting” or “dusting off” means the process whereby agents in seed coatings dust, flake and fall off a coated seed during and after the drying process, including during storage and transportation, unless the context clearly dictates otherwise. Dusting can result in a multitude of problems, including the clogging of seed drills.

The use of “coated seed” means a seed coated with one or more seed coating layers, unless the context clearly dictates otherwise.

The use of “shell” means the outermost portion of a seed or coated seed, unless the context clearly dictates otherwise. For an uncoated seed, the shell is the pericarp of the seed. For a coated seed, the shell is the outside of the outermost seed coating layer.

The use of “seed coating” means the coating of a coated seed, comprising one or more seed coating layers, unless the context clearly dictates otherwise.

The use of “seed coating layer” means a layer of one or more agents applied to the shell, unless the context clearly dictates otherwise.

The use of“first seed coating layer” means a seed coating layer that is closer to the pericarp than a second seed coating layer, unless the context clearly dictates otherwise.

The use of “second seed coating layer” means a seed coating layer that is farther from the pericarp than a first seed coating layer and closer to the pericarp than a third seed coating layer, unless the context clearly dictates otherwise.

The use of “third seed coating layer” means a seed coating layer that is farther from the pericarp than a first seed coating layer and a second seed coating layer, unless the context clearly dictates otherwise.

The use of “inner seed coating layer” means a seed coating layer that is closer to the pericarp than an outer seed coating layer, unless the context clearly dictates otherwise. An inner seed coating layer does not necessarily need to be the seed coating layer applied to the pericarp.

The use of “outer seed coating layer” means a seed coating layer that is farther from the pericarp than an inner seed coating layer, unless the context clearly dictates otherwise. The outer seed coating layer does not necessarily need to be the outermost seed coating layer.

The use of “seed coating process” means any process that results in one or more agents and a seed (or a coated seed) being brought together in such a way as to provide reasonably continuous contact between the agent and at least a portion of the shell to form a coated seed which persists during the storage, transporting, and planting of the coated seed, unless the context clearly dictates otherwise. Many seed coating processes are known in the prior art, including but not limited to, true seed coating, seed pelleting, and film coating. “Coating” a shell does not require that the agent(s) be uniformly distributed on the surface of the shell; nor does “coating” require the entire surface of the shell to be covered.

The use of “coating stabilizing layer” means a seed coating layer of clay mineral located between the shell and a seed coating layer of superabsorbent polymer, unless the context clearly dictates otherwise. Additional seed coating layers may exist between the coating stabilizing layer and the pericarp, and one or more additional seed coating layers may exist between the coating stabilizing layer and the seed coating layer of superabsorbent polymer.

The use of “clay mineral” means hydrous aluminum phyllosilicates, sometimes with variable amounts of iron, magnesium, alkali metals, alkaline earths, and other cations, unless the context clearly dictates otherwise.

The use of“bentonite” means an absorbent aluminum phyllosilicate clay mineral consisting mostly of montmorillonite, for example sodium bentonite, unless the context clearly dictates otherwise.

The use of “an effective amount of clay mineral to decrease the occurrence of dusting” means an effective amount of one or more clay minerals to stabilize a layer of superabsorbent polymer in a coating and decrease the occurrence of dusting, unless the context clearly dictates otherwise.

The use of “water-absorbing additive” means an additive able to absorb and retain water, unless the context clearly dictates otherwise. Examples of water-absorbing additives include, but not limited to, superabsorbent polymers.

The use of “superabsorbent polymer” means a polymer(s) which is adapted to imbibe or absorb, and retain, many times its own weight of fluid, such as water, unless the context clearly dictates otherwise. Superabsorbent polymers are also referred to as super-hydrating polymers, water-swellable polymers, and hydrogels.

The use of “filler” means an insoluble particulate material used to build-up the size of a coated seed, unless the context clearly dictates otherwise. Examples of fillers include, but are not limited to, mineral fillers and limestone.

The use of “limestone” means calcium carbonate (CaCO₃) based inorganic material, unless the context clearly dictates otherwise.

The use of “binder” means any suitable binder approved for agricultural use, including, but not limited to binders, adhesives, polymers, resins and the like, dispersed or dissolved in a carrier, which are suitable for binding one or more agents to a shell, unless the context clearly dictates otherwise. Examples of suitable binders include, but are not limited to binders selected from the group consisting of glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers. A suitable binder should not impair seed germination, should give the seeds a durable coating when the seeds are dry, and should be readily soluble in water so that the coating will not stick on the pericarp or seed coating layer when the seeds are wet. Preferred binders are water-soluble, but binders which are not water-soluble could be utilized.

The use of “carrier” means an aqueous carrier such as water, one or more solvents, or a combination of water and one or more solvents, unless the context clearly dictates otherwise. A carrier is used to carry an agent.

The use of “layer” means a substantially solid coating disposed on at least a portion of a substrate, unless the context clearly dictates otherwise.

The use of “additive” means any additional material or component, including but not limited to Rhizobium bacteria, MYCO SEED TREAT®, nutrient components, pesticides, fungicides, herbicides, buffers, biologicals to protect a developing seedling, fillers, agrochemicals, beneficial elements, zeolite, soil surfactants (wetting agents), vitamins, cofactors, penetrants, water absorbants, mold inhibitors, soil conditioners (polyacrylamide) carbohydrates, acids, and plant growth regulators, unless the context clearly indicates otherwise.

The use of “MYCO SEED TREAT®” or “MST” means a dry blend of plant-beneficial bacteria and fungi (including Mycorrhizae) accompanied by a nutrient package to support the bacteria and fungi during their initial stages of growth, produced by AgriEnergy Resources L.L.C.

The use of “zeolite” means microporous, aluminosilicate minerals, including all natural and manmade species of zeolites, unless the context clearly dictates otherwise. The zeolite can be in the form of pure compound, technical grade of the compound, or a formulation of the compound.

The use of “nutrient component” means a substance that provides nourishment essential for growth and the maintenance of life, unless the context clearly indicates otherwise. Examples of nutrient components include, but are not limited to micronutrients, macronutrients, and nutrients selected from the group consisting of nitrogen (N), phosphorus (P), potassium (K), calcium (Ca), magnesium (Mg), sulfur (S), boron (B), copper (Cu), iron (Fe), chloride (Cl), manganese (Mn), molybdenum (Mo), and Zinc (Zn).

The use of “pesticide” means a substance used for destroying insects or other organisms harmful to cultivated plants, unless the context clearly indicates otherwise. Examples of pesticides include, but not limited to, pesticides selected from the group consisting of organophosphate pesticides, carbamate pesticides, organochlorine insecticides, pyrethroid pesticides, and microbial pesticides.

The use of “fungicide” means a chemical that destroys fungus, unless the context clearly indicates otherwise. Examples of fungicides include, but not limited to, systemic fungicides and fungicides selected from the group consisting of mancozeb, tricyclazole, carbendazim, hexaconazole, metalaxyl, benomyl, difenoconazole, propiconazole, kitazin, tebuconazole, copper oxychloride, copper hydroxide, tridemorph and propineb.

The use of “herbicide” means a substance that is toxic to plants and is used to destroy unwanted vegetation, unless the context clearly indicates otherwise. Examples of herbicides include, but not limited to, herbicides selected from the group consisting of phenoxy acid, benzoic acid, dinitroaniline, bipyridylium, substituted urea, and arsenical.

### DETAILED DESCRIPTION

The following description provides examples of that which the inventor regards as his invention. As such, the embodiments discussed herein are merely exemplary in nature and are not intended to limit the scope of the invention, or its protection, in any manner. Rather, the description of these embodiments serves to enable a person of ordinary skill in the relevant art to practice the invention.

The inventor has found that the aforementioned dusting off issue can be addressed by coating the shell of a seed with an inner coating stabilizing layer, for instance comprising a clay mineral, such as bentonite clay, before the shell is coated with water-absorbing additives, such as a superabsorbent polymer.

Without being bound by any particular theory, it is believed that coating the shell with a coating stabilizing layer before adding a seed coating layer containing superabsorbent polymer alters the exchange of water during the seed coating process, resulting in less damage to the seed coating during the drying process and less dusting off. Explained a different way, the application of the inner coating stabilizing layer to the shell before application of water absorbing additives to the shell is believed to decrease dusting off by the inner coating stabilizing layer absorbing some of the excess water present in the binder used to apply the agents to the shell, thereby decreasing the water available to the water-absorbing additive after the water-absorbing additive is applied, resulting in the water-absorbing additive having a better opportunity to adhere to the seed coating layer the water-absorbing additive was applied to.

By increasing the amount of water-absorbing additive attached to each seed, the amount of water available for storing around each seed after planting is increased. With more water stored next to a germinating seed, the chance that seedling will survive, especially when there are times of little or no water available after planting, increases. Further, by decreasing dusting off (the degree of which can vary from coated seed to coated seed), the water-absorbing additive and additives are more evenly spread throughout bags of seed, better ensuring the majority of seedlings will all have the same chance at surviving and flourishing.

Disclosed herein are several exemplary seed coating compositions, coated seeds, methods of producing coated seeds, seed coating manufacturing processes, methods of creating seed coating compositions, processes of coating seeds, and methods of using coated seeds created utilizing one of the same. The exemplary seed coating compositions are for decreasing the occurrence of dusting in coated seeds, thereby increasing the quality of such coated seeds.

Exemplary seed coating compositions comprise a coating stabilizing layer applied to the shell of a seed, followed by a later seed coating layer comprising a water-absorbing additive. In such an arrangement, the coating stabilizing layer is inner to the outer water-absorbing additive layer.

In exemplary seed coating compositions, the inner coating stabilizing layer comprises a clay mineral, such as bentonite. The inner coating stabilizing layer may be applied directly to the pericarp, or may be applied to a seed coating layer. The inner coating stabilizing layer may be directly applied to the shell, may be applied to the shell via a carrier, or may be applied to the shell along with a binder for binding the inner coating stabilizing later to the shell, or may be otherwise applied. The application of the clay mineral to the shell forms the inner coating stabilizing layer. One or more inner coating stabilizing layers may be applied. One or more seed coating layers may be applied to the coated seed after the inner coating stabilizing layer is applied.

In exemplary seed coating compositions, a seed coating layer of water-absorbing additive is applied to the shell after the inner coating stabilizing layer was applied. The seed coating layer of water-absorbing additive may be directly applied to the shell, may be applied to the shell via a carrier and/or may be applied to the shell along with a binder for binding the water-absorbing additive to the shell.

In exemplary seed coating compositions, one or more seed coating layers of filler may be applied to the shell before the coating stabilizing layer is applied to the shell. Alternatively, or in addition, one or more seed coating layers of filler may be applied to the shell before the water-absorbing additive is applied to the shell. The purpose of the filler is to get the total weight (and size) of the coated seed to a desired weight/size for ease of planting. The filler may be directly applied to the shell, may be applied to the shell via a carrier, or may be applied to the shell along with a binder for binding the filler to the shell. For instance, the filler can be mixed with a water-based, water-soluble polymer and applied to the shell.

TABLE 1 provides a preferred coating percent to ratio of raw seed weight to filler weight to percent filler (of raw seed weight) for exemplary seed coating compositions. The coating percentages listed in TABLE 1 are not inclusive—exemplary seed coating compositions may have anything from no filler to more than an 80% coating of filler.

TABLE 1

| Coating % | Ratio of Raw Seed | wt % Filler |
|---|---|---|
| (approximate) | Weight to Filler Weight | (of Raw Seed Weight) |
| 1% | 0.01:1 | 1 wt % |
| 8% | 0.09:1 | 9 wt % |
| 34% | .5:1 | 50 wt % |
| 50% | 1:1 | 100 wt % |
| 60% | 1.5:1 | 150 wt % |
| 66% | 2:1 | 200 wt % |
| 75% | 3:1 | 300 wt % |
| 80% | 4:1 | 400 wt % |

One example of a filler that can be utilized in exemplary seed coating compositions is limestone. Limestone could also be utilized as a pH buffer. An additional filler that can be utilized in exemplary seed coating compositions is a clay mineral, such as bentonite. In some exemplary seed coating compositions, additional agents, such as bentonite or zeolite, can be added with the filler.

In exemplary seed coating compositions, any suitable binder may be used. The binder is for ensuring that the agent binds to the shell. When the binder dries on the coated seed, preferably less than ten-percent (10%) of the weight of the total binder applied will remain due to evaporation of the water and the fact that not all of the binder applied will stick to the uncoated seed/coated seed. The total amount of binder applied in an exemplary seed coating composition will vary based on the species of seed coated, and will vary based on the amounts of coatings applied to the seeds. An average application will use binder to clay mineral/water-absorbing additives/fillers/additives ratios from 1:3 to 1:6, and a binder to filler ratio of 1:3 to 1:4.

In an exemplary seed coating composition, the binder can be added to seeds before they are coated with any agents, during the time when they are coated with agents, or after they have been coated with one or more agents. The binder can also be mixed together with one or more agents before being applied to the shell.

Many techniques for applying coatings to seeds are known and may be used for coating a seed with exemplary seed coating compositions, including, but not limited to, seed pelleting, film coating, and true seed coating.

Seed pelleting is the deposition of at least one seed coating layer of an inert material onto at least a portion of the seed, so as to substantially increase the weight of the seed, and to improve the plantability of the seed. The main application of seed pelleting is to pelletize seeds that are hard to singulate (e.g., small, light, variably-sized, and/or irregularly-shaped seeds) into spherical, or near-spherical, capsules configured for precision sowing. Instead of oversowing raw, uncoated seed, and then subsequently thinning established plants, which can be very costly when seeds and labor are expensive, pelleted seeds can be precisely planted to achieve uniform spacing. Due to their high operational cost, seed pelleting processes are mainly used in the vegetable and flower seed sectors.

Film coating is the application of a continuous layer of a film, such as a polymer film, over at least a portion of a seed to control product dust-off. Film coating is also used for seed cosmetics and variety identification (e.g., by color). Film coating is mainly applied on vegetable seeds, because the high cost of the film coating polymer does not justify its value on low value seeds.

True seed coating may be defined as the addition of at least one seed coating layer of a material or materials that would result in a significant increase in seed weight, and/or size increase to at least a portion of the seed, but where the coated seed still retains the same shape as the raw. True seed coating is mainly employed to coat small-seeded, forage legume seeds, and grass seeds. The main purposes of true seed coating are to improve seed plantability, and to incorporate seed treatment chemicals, nutrients, and beneficial elements into the seed coating so as to meet the seedlings' early needs. Moreover, true seed coating has been proven to be the most efficient way of inoculating small-seeded, forage legume seeds.

Various techniques and equipment known in the seed coating art may be used for applying a seed coating composition to a seed. The process may be continuous or batch and typically involves tumbling the seed in the presence of the coating composition. Some drying of the coated seed may be required.

In an exemplary seed coating composition, formulations of the agents and additives can be prepared by admixing the compound with one or more adjuvants including diluents, extenders, carriers, surfactants, and conditioning agents to provide compositions in the form of particulate solids, solutions, dispersions, or emulsions. Such compositions include, for example, wettable powders, granulars, dusts, emulsifiable concentrates, and flowables.

The following numbered list of exemplary seed coating compositions is not intended as an exclusive list of all exemplary seed coating compositions, but is merely provided as a list of example compositions. A first exemplary seed coating composition comprises an inner coating stabilizing layer followed by an outer seed coating layer of water-absorbing additive.

A second exemplary seed coating composition comprises one or more of the numbered exemplary seed coating compositions where the inner coating stabilizing layer comprises an effective amount of clay mineral to decrease the occurrence of dusting.

A third exemplary seed coating composition comprises one or more of the numbered exemplary seed coating compositions where the inner coating stabilizing layer comprises an effective amount of clay mineral to decrease the occurrence of dusting, wherein the clay mineral is bentonite.

A fourth exemplary seed coating composition comprises one or more of the numbered exemplary seed coating compositions wherein the water-absorbing additive comprises super-hydrating polymer.

A fifth exemplary seed coating composition comprises one or more of the numbered exemplary seed coating compositions wherein a binder is applied before, with, or after the inner coating stabilizing layer.

A sixth exemplary seed coating composition comprises one or more of the numbered exemplary seed coating compositions wherein a binder is first applied to the pericarp of the seed, and once the seed has become saturated with the binder (for instance, when the seeds begin to adhere to one another), then powdered bentonite is layered onto the moistened seed.

A seventh exemplary seed coating composition comprises one or more of the numbered exemplary seed coating compositions further comprising a binder, wherein the binder comprises one or more of the following: molasses, corn syrup, sorghum, cane syrup, polyvinyl alcohol, polyvinyl acetate, Arabic gums, polyvinyl pyrrolidone, calcium lignosulfonate, and synthetic organic polymers.

An eighth exemplary seed coating composition comprises one or more of the numbered exemplary seed coating compositions wherein the coating stabilizing layer comprises a clay mineral.

A ninth exemplary seed coating composition comprises one or more of the numbered exemplary seed coating compositions wherein the clay mineral comprises bentonite clay.

A tenth exemplary seed coating composition comprises one or more of the numbered exemplary seed coating compositions wherein the water-absorbing additive is a superabsorbent polymer.

An eleventh exemplary seed coating composition comprises one or more of the numbered exemplary seed coating compositions further comprising at least one filler.

A twelfth exemplary seed coating composition comprises one or more of the numbered exemplary seed coating compositions further comprising at least one filler, wherein the filler is limestone.

A thirteenth exemplary seed coating composition comprises one or more of the numbered exemplary seed coating compositions wherein the inner coating stabilizing layer is approximately 4 wt % to 8 wt % of the weight of the uncoated seed.

A fourteenth exemplary seed coating composition comprises one or more of the numbered exemplary seed coating compositions wherein the water-absorbing additive is approximately 2 wt % to 4 wt % of the weight of the uncoated seed, and more preferably around 2 wt % of the weight of the uncoated seed.

A fifteenth exemplary seed coating composition comprises one or more of the numbered exemplary seed coating compositions wherein the shell is coated with one or more agents to form a coated seed before the inner coating stabilizing layer is applied.

A sixteenth exemplary seed coating composition comprises one or more of the numbered exemplary seed coating compositions wherein the shell is coated with one or more agents to form a coated seed before the inner coating stabilizing layer is applied, and wherein additional seed coating layers are applied to the coated seed before the inner coating stabilizing layer is applied.

A seventeenth exemplary seed coating composition comprises one or more of the numbered exemplary seed coating compositions wherein additional seed coating layers comprising one or more agents are applied to the coated seed after the application of the seed coating layer of water-absorbing additive.

An eighteenth exemplary seed coating composition comprises one or more of the numbered exemplary seed coating compositions further comprising at least one additive.

A nineteenth exemplary seed coating composition comprises one or more of the numbered exemplary seed coating compositions wherein the seed coating composition comprises at least one of the following additives: Rhizobium bacteria, MYCO SEED TREAT®, nutrient components, pesticides, fungicides, herbicides, buffers, biologicals to protect a developing seedling, fillers, agrochemicals, beneficial elements, zeolites, and plant growth regulators.

A twentieth exemplary seed coating composition comprises a combination of two or more of the numbered exemplary seed coating compositions.

A twenty-first exemplary seed coating composition comprises one or more of the numbered exemplary seed coating compositions wherein the seed coating composition, dry on seed, comprises: about 4 wt % to about 8 wt % of the weight of the uncoated seed of at least one clay mineral, preferably about 4 wt % of the weight of the uncoated seed; about 2 wt % to about 4 wt % of the weight of the uncoated seed of at least one water-absorbing additive, preferably about 2.0 wt % of the weight of the uncoated seed; about 1 wt % to about 5 wt % of the weight of the uncoated seed of at least one binder, preferably about 2.2 wt % of the weight of the uncoated seed; 50 wt % to 150 wt % of the weight of the uncoated seed of at least one filler, preferably 100 wt %; and 0 wt % to 10 wt % of the weight of the uncoated seed of one or more additives, preferably 4.2 wt % of the weight of the uncoated seed. Such an exemplary seed coating composition would be a variable application—a person having ordinary skill in the art would adjust the various rates as needed for the behavior of all the components during the particular lot of seed.

A twenty-second exemplary seed coating composition comprises one or more of the numbered exemplary seed coating compositions wherein the seed coating composition comprises 50% coated alfalfa seed when dry. The use of “50% coated” referring to a 1:1 ratio of filler to raw seed weight. With 454 g of seed, 454 g of limestone is used (a 1:1 ratio), 10 g of binder (when dry, applied as 100 g of liquid binder (900, water, 10% polymer binder), 5.44 g of inoculant as an additive, 9.08 g (2%) of water-absorbing additive, 13.62 g (3%) of MST as an additive, and 22.7 g (5%) clay mineral (bentonite clay). Such an exemplary seed coating composition would be a variable application—a person having ordinary skill in the art would adjust the various rates as needed for the behavior of all the components during the particular lot of seed.

A twenty-third exemplary seed coating composition comprises one or more of the numbered exemplary seed coating compositions wherein the wt % of the inner coating stabilizing layer is 200/o of the wt % of the water-absorbing additive.

A twenty-fourth exemplary seed coating composition comprises one or more of the numbered exemplary seed coating compositions wherein the wt % of the binder is 25% the wt % of the filler.

A twenty-fifth exemplary seed coating composition comprises one or more of the numbered exemplary seed coating compositions wherein the wt % of the filler is between 50% of the raw seed weight and up to 400% of the raw seed weight.

While these are preferred exemplary seed coating compositions, a skilled artisan will be able to select the appropriate components in an exemplary seed coating composition based on various considerations, including the intended use of the seed, the intended seed type(s) with will be used, the intended environment within which the seed will be used, and the equipment and/or accessories with which the seed is intended to be used, among other considerations. As such, the preceding numbered list is not intended as an exclusive list of all exemplary seed coating compositions, but is merely provided as a list of a number of example compositions.

A first exemplary method for producing coated seeds comprises coating seeds with one or more of the numbered exemplary seed coating compositions listed above.

A second exemplary method for producing coated seeds comprises a number of steps. In a first step, a binder is applied to the pericarp of a quantity of seeds until the seeds are saturated with the binder. Once the seeds have become saturated with the binder, a quantity of mineral filler is then layered onto the binder coated seeds to create a seed coating layer. Binder preferably continues to be added while the mineral filler is layered on. After the mineral filler seed coating layer is created, then a quantity of clay mineral is layered onto the coated seed. The clay mineral forming an inner coating stabilizing layer on the coated seed. Binder preferably continues to be added while the inner coating stabilizing layer is formed. Once the desired amount of clay mineral is applied to the seed to form a coated seed, a quantity of water-absorbing additive is added to the coated seed. Once the desired amount of water-absorbing additive has been added to the coated seed, the coating process ends. After the coating process ends, the seeds are compacted, and then are moved to a drying apparatus where the seeds are dried.

A third exemplary method for producing coated seeds comprises a number of steps. In a first step, a binder is applied to the pericarp of a quantity of seeds until the seeds are saturated with the binder. Once the seeds have become saturated with the binder, a quantity of at least one filler and a quantity of at least one additive is layered onto the binder coated seeds in one or more layers to create a coated seed. Binder preferably continues to be added while the coated seed is formed. After the coated seed is formed, then a quantity of clay mineral is layered onto the coated seed. The clay mineral forming an inner coating stabilizing layer on the coated seed. Binder preferably continues to be added while the inner coating stabilizing layer is formed. Once the desired amount of clay mineral is applied to the seed to form a coated seed, a quantity of water-absorbing additive is added to the coated seed. Once the desired amount of water-absorbing additive has been added to the coated seed, the coating process ends. After the coating process ends, the seeds are compacted, and then are moved to a drying apparatus where the seeds are dried.

A fourth exemplary method for producing coated seeds comprises one of the above exemplary methods for producing coated seeds wherein one or more seed coating layers of clay minerals, fillers, and/or additives are added to the coated seed, with or without the application of additional binder, after the clay mineral is added, but before the water-absorbing additives are added.

A fifth exemplary method for producing coated seeds comprises one of the above exemplary methods for producing coated seeds wherein the binder is a liquid binder comprising a 10 wt % solution in water (100 g of binder is 90% water and 10% polymer).

A sixth exemplary method for producing coated seeds comprises one of the above exemplary methods for producing coated seeds wherein the water-absorbing additive is added to the coated seed without additional binder being applied with the water-absorbing additive. This is done to minimize the absorption of water from the liquid binder into the water-absorbing additive.

A seventh exemplary method for producing coated seeds comprises one of the above exemplary methods for producing coated seeds wherein the amount of water-absorbing additive applied to the coated seed is preferably 1.0 wt % to 3.0 wt % of the weight of the uncoated seed, and more preferably 2.0 wt % of the weight of the uncoated seed, but could be more or less than that amount. Once a desired amount of water-absorbing additive has been added to the coated seed, application of water-absorbing additive ends.

An eighth exemplary method for producing coated seeds comprises one of the above exemplary methods for producing coated seeds wherein the clay mineral is bentonite. Preferably the bentonite is powdered.

A ninth exemplary method for producing coated seeds comprises one of the above exemplary methods for producing coated seeds wherein the filler comprises limestone.

A tenth exemplary method for producing coated seeds comprises one of the above exemplary methods for producing coated seeds wherein at least one of the filler and the clay minerals are mixed with the binder before application to the seeds.

An eleventh exemplary method for producing coated seeds comprises one of the above exemplary methods for producing coated seeds wherein one or more seed coating layers of clay minerals, fillers, and/or additives are added to the seed after the clay mineral is added.

A twelfth exemplary method for producing coated seeds comprises one of the above exemplary methods for producing coated seeds wherein the coating of clay mineral comprises an effective amount of clay mineral to decrease the occurrence of dusting off.

A thirteenth exemplary method for producing coated seeds comprises one of the above exemplary methods for producing coated seeds wherein the amount of clay mineral applied to the binder coated seed is 4 wt % to 8 wt % of the weight of the uncoated seed. In other exemplary methods for producing coated seeds, the amount could be more or less than that amount.

A thirteenth exemplary method for producing coated seeds comprises one of the above exemplary methods for producing coated seeds wherein the amount of filler applied to the currently coated seed is preferably about a 1% coating (0.01 times the weight of the currently coated seed) to an 80% coating (4.0 times the weight of the currently coated seed) or higher, and more preferably about 34% coating (0.5 times the weight of the currently coated seed) to about a 50% coating (1.0 times the weight of the currently coated seed). In other exemplary methods for producing coated seeds, the amount could be more or less than that amount. The coating percent listed is not determined with respect to the uncoated seed weight, but is instead determined with respect to the currently coated seed weight before application of the filler.

A fourteenth exemplary method for producing coated seeds comprises a combination of one or more of the above exemplary methods for producing coated seeds.

A first exemplary coated seed comprises one of the exemplary seed coating compositions on a seed.

A second exemplary coated seed comprises a seed, coating the seed with a coating stabilizing layer comprising bentonite clay to produce a stabilized seed unit, and coating the stabilized seed unit with a superabsorbent polymer to create the coated seed.

A third exemplary coated seed comprises a seed, coating the seed with at least one of a filler, a binder, or an additive to create an agent coated seed, coating the agent coated seed with a coating stabilizing layer comprising bentonite clay to produce a stabilized seed unit, and coating the stabilized seed unit with a superabsorbent polymer to create the coated seed.

A first exemplary seed coating manufacturing processes comprises the steps of coating a seed with a seed coating composition comprising bentonite to create a coated seed, and then coating the coated seed with a superabsorbent polymer.

Exemplary processes of coating seeds with an exemplary seed coating composition comprise the steps of providing a quantity of seeds, coating the seeds with a quantity of clay mineral, coating the seeds with a quantity of superabsorbent polymer, compacting the coated seeds, drying the coated seeds, and screening the dried, coated seeds.

A first exemplary process of coating seeds with an exemplary seed coating composition comprises the steps of providing a quantity of seeds, coating the seeds with a quantity of binder, coating the binder coated seeds with a mineral filler and an additional quantity of binder, coating the seeds with a quantity of clay mineral and an additional quantity of binder, coating the seeds with a quantity of superabsorbent polymer, compacting the coated seeds, drying the coated seeds, and screening the dried, coated seeds. Preferably, the clay mineral is bentonite. Preferably, the mineral filler is limestone.

A second exemplary process of coating seeds with an exemplary seed coating composition comprises coating seeds with one of the exemplary seed coating compositions.

A third exemplary process of coating seeds with an exemplary seed coating composition utilizes two phases, a wet phase and a dry phase. In the wet phase of coating, at least one liquid binder is introduced to the seed. Then a filler is introduced to the mixture, and the mixture if further mixed. Then additional filler is introduced along with additional binder to the mixture and the mixture is further mixed. After coating the seed with at least one binder and filler, at least one clay mineral is introduced to the mixture with an additional quantity of liquid binder, and the mixture is further mixed. Then a water-absorbing additive is introduced to the mixture, and the mixture is further mixed. The resulting mixture is then transferred to a processing line for the compacting of the coated seed, and to start the dry phase. The wet mixture is rolled within an inclined “rolling” drum, to compact the coating on the seed. After mixing, the coated seed is dried. A heated fluid bed drier, or other drying apparatus/process, can be utilized in this step. The binder hardens during the drying process, ensuring a durable coating. To arrive at a uniform product after drying, the dried seed is screened to remove any remaining dust that did not adhere to the seed coat, and any agglomerated seeds or coating material. After screening, the coated seed is then bagged for shipment and sales.

In a fourth exemplary process of coating seeds with an exemplary seed coating composition, one or more ROTOSTAT® emulsifiers are used. The ROTOSTAT® emulsifiers incorporate a rotating pan at the bottom of a vertical cylinder. The pan throws the seed against the inside wall of the cylinder, and as the seed rolls around the wall, atomized binder is applied from a spinning disk in the center of the cylinder. After coating the seed with the binder, limestone is then applied, for instance, by a hopper located above the cylinder, additional binder is added, and the mixture is further mixed. As the seed rolls around the inside wall of the cylinder, the coating is packed on the seed. After the limestone seed coating layer is added, then finely ground bentonite powder is then applied, for instance, by a hopper located above the cylinder, additional binder is added, and the mixture is further mixed. As the seed rolls around the inside wall of the cylinder, the coating is packed on the seed. Then, water-absorbing additive is applied, for instance, by a hopper located above the cylinder, and the mixture is further mixed. After mixing, the cylinders drop the coated seeds into a surge hopper with a belt on the bottom, conveying the seeds to a series of fluid bed dryers, or other drying apparatus/process, with individually controlled temperatures wherein the coated seeds are dried. The binder hardens during the drying process, ensuring a durable coating on the seeds. To arrive at a uniform product after drying, the dried seeds are screened to remove any remaining dust that did not adhere to the seed, and to remove any agglomerated seeds or coating material. After screening, the coated seeds are then bagged for shipment and sales.

In a fifth exemplary process of coating seeds with an exemplary seed coating composition, one or more ROTOSTAT® emulsifiers are used. The ROTOSTAT® emulsifiers incorporate a rotating pan at the bottom of a vertical cylinder. The pan throws the seed against the inside wall of the cylinder, and as the seed rolls around the wall, atomized binder is applied from a spinning disk in the center of the cylinder. After coating the seed with the binder, fillers and additives are then applied, for instance, by a hopper located above the cylinder, additional binder is added, and the mixture is further mixed. As the seed rolls around the inside wall of the cylinder, the fillers and additives form a coating that is packed on the seed. After the fillers and additives seed coating layer is added, then finely ground bentonite powder is then applied, for instance, by a hopper located above the cylinder, additional binder is added, and the mixture is further mixed. As the seed rolls around the inside wall of the cylinder, the coating is packed on the seed. Then, water-absorbing additive is applied, for instance, by a hopper located above the cylinder, and the mixture is further mixed. After mixing, the cylinders drop the coated seeds into a surge hopper with a belt on the bottom, conveying the seeds to a series of fluid bed dryers, or other drying apparatus/process, with individually controlled temperatures wherein the coated seeds are dried. The binder hardens during the drying process, ensuring a durable coating on the seeds. To arrive at a uniform product after drying, the dried seeds are screened to remove any remaining dust that did not adhere to the seed, and to remove any agglomerated seeds or coating material. After screening, the coated seeds are then bagged for shipment and sales.

A sixth exemplary process of coating seeds, comprises the steps of: providing a quantity of seeds; coating the seeds with a binder to create coated seeds; coating the coated seeds with a filler; coating the seeds with a filler and additional binder; coating the filler coated seeds with a clay mineral and additional binder; coating the seeds with a water-absorbing additive; compacting the coated seeds; and drying the coated seeds. Preferably, the coatings comprise about 4 wt % of the weight of the uncoated seed of the clay mineral; about 2 wt % of the weight of the uncoated seed of the water-absorbing additive; and about 100 wt % of the weight of the uncoated seed of the filler. Further preferably, the clay mineral is bentonite clay, the water-absorbing additive is superabsorbent polymer, and the filler is limestone.

Exemplary processes of coating seeds with an exemplary seed coating composition can utilize other types of mixing devices/equipment, including container mixing, horizontal paddle style batch mixers, rotating disc inside unmoving cylinder mixers, spray mixers, agitators, ribbon blenders, drum mixers, and combinations of the same. While many different mixing devices and equipment types are mentioned above, a skilled artisan will be able to select appropriate equipment or combination of equipment used in a process according to a particular embodiment based on various considerations, including the environment within which the coated seed is intended to be used, and the components of the coated seeds. Materials, equipment and processes hereinafter discovered and/or developed that are determined to be suitable for use in creating coated seeds would also be considered suitable for use in an exemplary process.

Exemplary methods of using a seed coating composition comprise coating a seed with one of the exemplary seed coating compositions.

Exemplary seed manufacturing process comprises coating a seed with one of the exemplary seed coating compositions.

It is noted that all formulas and compositions of the various described embodiments can be combined in any suitable configuration for inclusion in a seed coating according to a particular embodiment. For example, a seed coating according a particular embodiment can include neither, one, or both of a binder and the additives described above.

Any suitable agents can be used to form the various components of the seed coating, and a skilled artisan will be able to select appropriate materials for a seed coating according to a particular embodiment based on various considerations, including the intended seed type(s) with which the composition will be used, the intended environment within which the composition will be used, and the equipment and/or accessories with which the composition is intended to be used. Materials hereinafter discovered and/or developed that are determined to be suitable for use in seed coating compositions would also be considered suitable for use in a seed coating composition according to a particular embodiment.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A coated seed comprising:
a seed, said seed having a pericarp; and
a seed coating on said seed,
wherein said seed coating comprises a plurality of seed coating layers, said plurality of seed coating layers comprising a first seed coating layer on said pericarp, a second seed coating layer applied after the first seed coating layer, and a third seed coating layer applied after the second seed coating layer,
wherein said first seed coating layer comprises a filler,
wherein said second seed coating layer comprises a clay mineral, and
wherein said third seed coating layer comprises a water-absorbing additive.

2. The coated seed of claim 1, wherein said clay mineral comprises bentonite.

3. The coated seed of claim 1, wherein said water-absorbing additive comprises a superabsorbent polymer.

4. The coated seed of claim 1, wherein said seed coating further comprises a binder for binding the seed coating layers to the seed.

5. The coated seed of claim 4, wherein said binder comprises at least one binder selected from the group consisting of: glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers.

6. The coated seed of claim 1, wherein said seed coating comprises:
about 4 wt % of the weight of the seed of said clay mineral, and
about 2 wt % of the weight of the seed of said water-absorbing additive.

7. The coated seed of claim 6, wherein said seed coating comprises about 100 wt % of the weight of the seed of said filler.

8. The coated seed of claim 6, further comprising about 0 wt % to about 2 wt % of the weight of the seed of at least one additive selected from the group consisting of: Rhizobium bacteria, nutrient components, pesticides, fungicides, herbicides, buffers, biologicals, agrochemicals, beneficial elements, zeolite, soil surfactants, vitamins, cofactors, penetrants, water absorbants, mold inhibitors, soil conditioners, carbohydrates, acids, and plant growth regulators.

9. The coated seed of claim 6, further comprising about 2 wt % of the weight of the seed of at least one additive selected from the group consisting of: glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers.

10. The coated seed of claim 1, further comprising at least one additional seed coating layer, said at least one additional seed coating layer applied after the application of the first seed coating layer and before the application of the second seed coating layer, said at least one additional seed coating layer comprising at least one additive selected from the group consisting of: Rhizobium bacteria, nutrient components, pesticides, fungicides, herbicides, buffers, biologicals, agrochemicals, beneficial elements, zeolite, soil surfactants, vitamins, cofactors, penetrants, water absorbants, mold inhibitors, soil conditioners, carbohydrates, acids, and plant growth regulators.

11. The coated seed of claim 1, wherein said first seed coating layer further comprises at least one additive selected from the group consisting of: Rhizobium bacteria, nutrient components, pesticides, fungicides, herbicides, buffers, biologicals, agrochemicals, beneficial elements, zeolite, soil surfactants, vitamins, cofactors, penetrants, water absorbants, mold inhibitors, soil conditioners, carbohydrates, acids, and plant growth regulators.

12. The coated seed of claim 1, wherein said filler is limestone.

13. The coated seed of claim 1, wherein said seed coating comprises about 4 wt % to about 8 wt % of the weight of the seed of said clay mineral, and about 2 wt % to about 4 wt % of the weight of the seed of said water-absorbing additive.

14. A coated seed comprising:
a seed, said seed having a pericarp;
a seed coating on said seed; and
a binder for binding the seed coating layers to the seed, wherein said binder comprises at least one binder selected from the group consisting of: glues, stickers, water soluble adhesives, molasses, corn syrup, sorghum, cane syrup, polyvinyl alcohol, polyvinyl acetate, Arabic gums, polyvinyl pyrrolidone, calcium lignosulfonate, and synthetic organic polymers;
wherein said seed coating comprises a plurality of seed coating layers, said plurality of seed coating layers comprising a first seed coating layer on said pericarp, a second seed coating layer applied after the first seed coating layer, and a third seed coating layer applied after the second seed coating layer,
wherein said first seed coating layer comprising limestone filler;
wherein said second seed coating layer comprises bentonite; and
wherein said third seed coating layer comprises a water-absorbing additive.

15. The coated seed of claim 14 wherein said first seed coating layer further comprises at least one additive selected from the group consisting of: Rhizobium bacteria, nutrient components, pesticides, fungicides, herbicides, buffers, biologicals, agrochemicals, beneficial elements, zeolite, soil surfactants, vitamins, cofactors, penetrants, water absorbants, mold inhibitors, soil conditioners, carbohydrates, acids, and plant growth regulators.

16. The coated seed of claim 14, wherein said seed coating comprises about 4 wt % of the weight of the seed of said bentonite, about 2 wt % of the weight of the seed of said water-absorbing additive, about 100 wt % of the weight of the seed of said filler.

17. A process of coating seeds, comprising the steps of:
providing a quantity of seeds;
coating the seeds with a quantity of binder;
coating the binder coated seeds with a mineral filler and an additional quantity of binder;
coating the seeds with a quantity of clay mineral and an additional quantity of binder;
coating the seeds with a quantity of superabsorbent polymer;
compacting the coated seeds;
drying the coated seeds; and
screening the dried, coated seeds.

18. The process of coating seeds of claim 17, further comprising the step of bagging the dried, coated seeds after screening.

19. The process of coating seeds of claim 17, wherein said seed coatings comprises:
clay mineral in the amount of about 4 wt % to about 8 wt % of the weight of the uncoated seed;
water-absorbing additive in the amount of about 2 wt % to about 4 wt % of the weight of the uncoated seed; and
mineral filler in the amount of about 1 wt % to about 80 wt % of the current weight of the coated seed.

20. The process of coating seeds of claim 17, wherein said clay mineral is bentonite clay, wherein said water-absorbing additive is superabsorbent polymer, and wherein said mineral filler is limestone.
